(19) United States
(12) Patent Application Publication
(10) Pub. No.: US 2019/0138005 A1
(43) Pub. Date: May 9, 2019

(54) Unmanned Aerial Vehicle Damage Mitigation System

(71) Applicant: Arthur Wigell, Warrnambool (AU)

(72) Inventor: Arthur Wigell, Warrnambool (AU)

(21) Appl. No.: 15/878,503

(22) Filed: Jan. 24, 2018

Related U.S. Application Data
(60) Provisional application No. 62/583,771, filed on Nov. 9, 2017.

(51) Int. Cl. G05D 1/00; B64C 39/02; B64D 17/80; G01S 19/13

(52) U.S. Cl. CPC G05D 1/0088; B64C 39/024; B64D 17/80; B64D 2045/0065; B64C 2201/027; B64C 2201/108; G01S 19/13

(57) ABSTRACT

An unmanned aerial vehicle (“UAV) damage mitigation system includes a drone housing, a processor, a memory, an inertial measurement unit (“IMU”), and associated electronics configured to determine if the drone is experiencing a failure event or is in danger of crashing. If such a failure is indicated, then the drone includes a parachute, alarm, and programming intended to mitigate or minimize damage to people and property on the ground. The UAV damage mitigation system also includes a mobile software application that is notified if the drone is experiencing a catastrophic event, and is notified of all other aerial vehicles in a proximity to the drone housing.

### REFERENCE TO RELATED APPLICATIONS

This application claims the benefit of Provisional patent application No. 62/583,771, filed Nov. 9, 2017 entitled Drone Having Catastrophic Failure Mitigation, which is incorporated herein in its entirety.

### BACKGROUND OF THE INVENTION

The present invention relates generally to unmanned aerial vehicles (UAVs) and, more particularly, to drones having components and methods for mitigating damage to property and personal harm caused when a drone suffers a catastrophic or unrecoverable loss of power or control and falls to the ground. Further, the present invention involves components to enhance finding a lost or crashed drone.

Unmanned aerial vehicles, known more commonly as drones, are becoming increasingly accepted as a normal part of everyday life. Drones are so much more than toys for children or hobbyists. No longer are drones only used for military or law enforcement purposes. Instead, drones are being used in farming, ranching, package delivery, and other common applications. Whether used for surveillance, exploration, or hobby, the danger of a drone suffering catastrophic failure, i.e. ceasing to stay airborne, may lead to damage to property or harm to persons on the ground. For instance, if a drone has engine failure or loses contact with the controller of its flight path, the drone may crash by dropping on a car, livestock, house, building, or, worse yet, onto a human being.

Therefore, it would be desirable to have a drone equipped with devices, modules, and programming configured to detect any failure of the flight system or to detect that a crash is imminent and then take actions to slow the drone's descent to the ground, to warn people on the ground of a potential impact, to notify emergency or other authorities, and to initiate means for locating the disabled drone.

### SUMMARY OF THE INVENTION

An unmanned aerial vehicle (“UAV) damage mitigation system according to the present invention includes a drone housing, a processor, a memory, an inertial measurement unit (“IMU”), and associated electronics configured to determine if the drone is experiencing a failure event or is in danger of crashing. If such a failure is indicated, then the drone includes a parachute, alarm, and programming intended to mitigate or minimize damage to people and property on the ground. The UAV damage mitigation system also includes a mobile software application that is notified if the drone is experiencing a catastrophic event, and is notified of all other aerial vehicles in a proximity to the drone housing.

Therefore, a general object of this invention is to provide a drone having a plurality of safety mechanisms configured to protect the lives and property of civilians in case of catastrophic loss of power or flight integrity of the drone.

Another object of this invention is to provide a drone, as aforesaid, having a parachute configured to slow the drone's descent back to Earth when catastrophic failure is detected and the parachute is deployed.

Still another object of this invention is to provide a drone, as aforesaid, that continuously logs its own global position and, upon detecting catastrophic failure, transmits its associated global position data to authorities or other predetermined contacts.

Yet another object of this invention is to provide a drone, as aforesaid, having a transponder configured to provide a reconnaissance signal in response to a search signal or automatically upon a crash or the like.

A further object of this invention is to provide a drone, as aforesaid, having a visual and/or audible alarm capable of warning civilians on the ground that the drone is disabled and will be impacting the ground or property.

A still further object of this invention is to provide a drone, as aforesaid, having a mobile application configured to alert a user of catastrophic failure of the drone and a global position of the respective drones in a proximity to the subject drone.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a drone according to a preferred embodiment of the present invention;

FIG. 2 is a block diagram of electronic components of the drone as in FIG. 1;

FIG. 3 is a perspective view of a parachute deployed from the drone according to the present invention;

FIG. 4 illustrates a display of a collision system in use with the present invention;

FIG. 5 is a flowchart illustrating the logic of an operation of the present invention;

FIG. 6a is a perspective view of a buoyancy device according to the present invention, illustrated in a deflated configuration; and

FIG. 6b a perspective view of the buoyancy device as in FIG. 6a, illustrated in an inflated configuration.

### DESCRIPTION OF THE PREFERRED EMBODIMENT

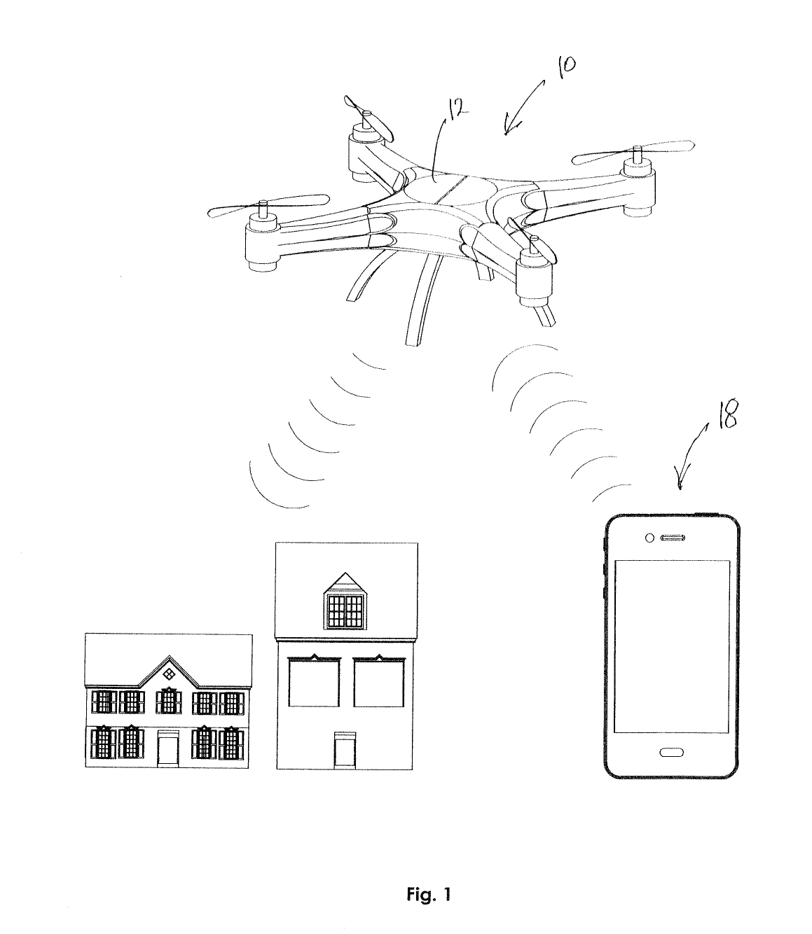

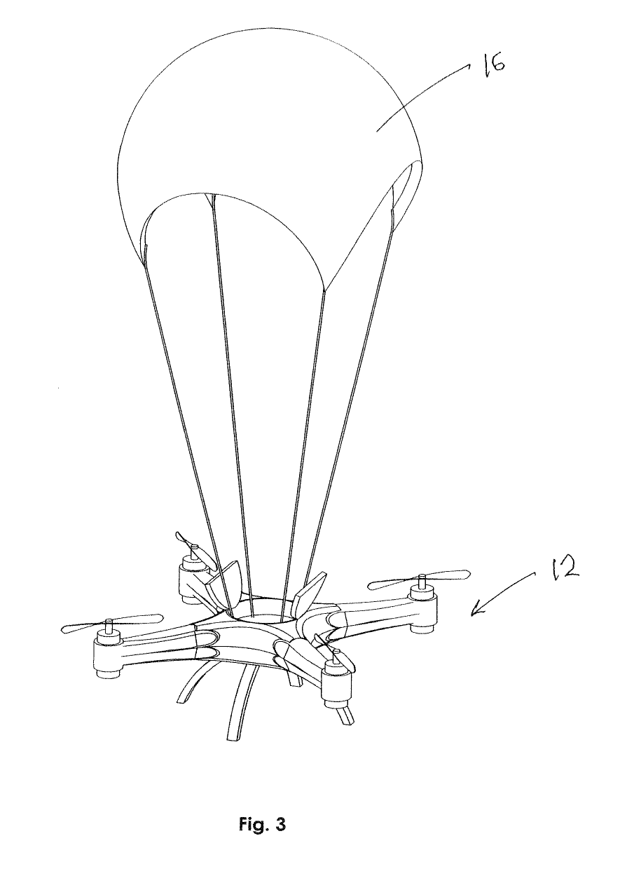

A drone having components and methods for mitigating damage to property and personal harm caused when a drone suffers a catastrophic or unrecoverable loss of flight integrity according to a preferred embodiment of the present invention will now be described in detail with reference to FIGS. 1 to 6b of the accompanying drawings. The drone 10 according to the present invention includes a drone housing 12 defining an interior area in which many electronics items and a parachute 16 may be contained.

The drone 10 includes a lift system capable of lifting and guiding the drone 10 into the ambient air. The figures illustrate the drone 10 in the form of quad-copter having a lift system that includes four propeller modules 14 although many housing and propeller configurations would also work. The drone may include an inertial measurement unit (“IMU) having an accelerometer, gyroscope, and magnetometer. The IMU 34 is capable of determining the drone's orientation in the sky and, in cooperation with a processor 20, is capable of determining if the drone's orientation and movement is indicative of catastrophic failure and a potential or imminent crash landing.

Now with more specific reference to the IMU 34, the accelerometer is configured to detect a rate of acceleration, for example, the motion of the drone 10, and to generate acceleration data. The gyroscope is configured to detect rotational movement, for example, the angular motion of the drone housing. The accelerometer and gyroscope can each provide 3 distinct channels of data in the x, y, z axis of real world motion. Therefore, six (6) distinct attributes of motion can be represented with just those two components. For example, a dual-axis (2-axis) solid state accelerometer can be used to detect acceleration in 2 directions versus a triple axis accelerometer (3 axis) accelerometer may be used to detect acceleration forces in three dimensions (x, y, and z axis of motion). Further, solid state combinations of accelerometers, gyroscope, and magnetometers may be employed to provide maximum position and motion data.

The data captures can be broken down into both translational and rotational movement. Translational movement refers to up/down, left/right, forward/backward movement. Rotational movement refers to pitch, roll, and yaw. The accelerometer measures non-gravitational acceleration forces in the translational movement. The relationship of each coordinate (x, y, z) to the force of the gravity constant of 9.8 m/s² will also detect if the object is straight up and down or tilted along one of the other axes.

Unlike the accelerometer, the gyroscope can measure rotational forces so it measures the speed of rotation around an axis, also called angular velocity. It measures the degrees of rotation per second or the revolutions per second around an axis. It is not concerned with the translational movement of the object so if one could theoretically hold a wheel perfectly still on all its axes but ran around the room with it, it would not register any change of the angular velocity.

A magnetometer is configured to generate overall spatial orientation and to generate orientation data. The magnetometer is configured to calibrate the IMU 34 by verifying, confirming, or otherwise correcting errors generated by the accelerometer and gyroscope. The magnetometer is in essence configured to provide a means to reduce the error that can be present in the other sensor. It is not measuring a “new” axis that the other two sensors miss but rather, it allows for the fusion of the sensors to provide the opportunity for a better accuracy outcome. The IMU data generation is important in that the IMU 34 can determine the at-rest angle of the drone housing as well as the in-motion position.

The motion and rotational data from the IMU 34 described above may be analyzed by circuitry or processor 20 pursuant to programming so as to determine if the present motion of the drone housing 12 is indicative of a lift system failure, other component malfunction, or that a crash is inevitable or imminent. More particularly, the present invention may include a processor 20 and a non-volatile memory 22 in data communication with the processor 20, the memory 22 being configured with data structures capable of storing data and programming instructions. The processor 20 is configured to execute respective programming instructions and to thereby actuate or energize various other electronic or mechanical components as will be described below. It is understood that the processor executing programming may be referred to as the processor “being programmed” a certain way. A battery 24 may be situated within the interior space of the drone housing 12 and electrically connected to the processor 20 and other electronics to be described below. The battery 24 may be in communication with an external charging port such that the battery 24 may be connected to an external AC power source for recharging. The battery 24 may be recharged with a traditional charger plugged into AC power or using inductive charging means. In addition, an altimeter 36 may be positioned in the drone housing 12 and in data communication with the processor 20, the altimeter 36 being configured primarily to determine an elevation or height of the drone's current flight position.

More particularly, data from the IMU 34 (e.g. accelerometer, gyroscope, or altimeter 36 data) may be analyzed by the processor 20 under program control to determine if the drone housing 12 is moving (i.e. flying or hovering) in a stable and expected manor versus flying or hovering erratically or in a manor indicative of lift system failure (a.k.a. a failure event) or falling in altitude so as to be indicative of an imminent crash. If such a failure event is determined, then the drone's electronics are capable of initiating emergency procedures as will be described below.

First, the drone 10 may include a parachute 16 and a parachute deployment structure. When the processor 20 determines that the lift system has failed or that the IMU 34 is indicative that the drone housing 12 is plummeting to the Earth, the processor 20, under programming control, may actuate the parachute deployment structure to deploy the parachute 16 from the drone housing 12 so as to decrease the rate of speed of descent of the drone housing 12 to the Earth.

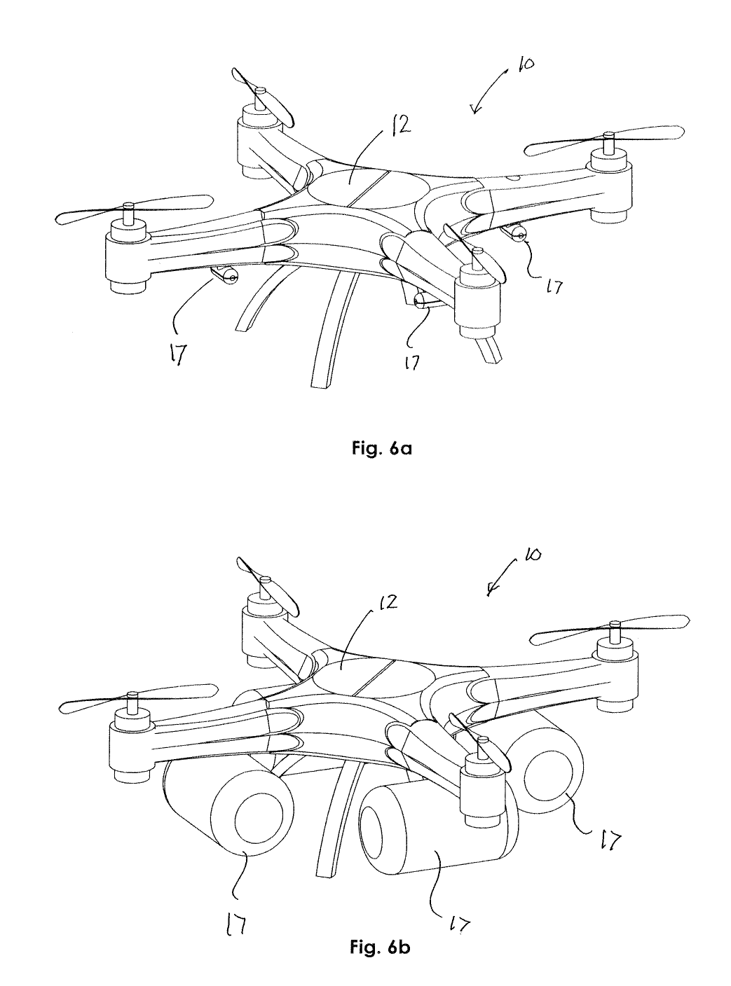

Similarly, the drone 10 may include a buoyancy device 17 that is operable to fill with air, i.e. to inflate, when energized so render the drone 10 with the ability to float in the case drone housing 12 falls into a body of water (FIG. 6). Specifically, an buoyancy device 17 may be mounted to each propeller module 14 of the drone housing 12 and is configured to move from a deflated configuration (FIG. 6a) to an inflated configuration (FIG. 6b) very rapidly, such as through a chemical reaction in the manner of deployment of an automobile airbag. Each buoyancy device 17 may be electrically connected to the processor 20 and may include a sensor which detects if a water landing has been experienced, the sensor being operatively connected to the processor 20 which then energies the buoyancy device 17 to inflate. Alternatively, the buoyancy device 17 may be actuated upon receipt of an associated signal received from a remote location, such as by a remote operator of the drone who may realize that a water impact is imminent and then signal the buoyancy device 17 to inflate. In addition, the buoyancy device 17 may be manually or automatically actuated when there are other indicators of an imminent crash as the buoyancy device 17 would be a damage mitigation device to facilitate a softer emergency landing.

Next, the drone 10 may include a communications module 26 positioned within the interior area of the drone housing 12 and in data communication with the processor 20 or equivalent circuitry. The communications module 26 may include a transmitter configured to transmit an emergency signal and may include mobile telephonic components capable of sending text or cellular signals or other components capable of sending emergency signals. Specific programming may cause the processor 20 to actuate the communications module 26 to transmit an emergency message to police or rescue authorities or to another central command center if catastrophic failure of the lift system is determined or if a crash is imminent as described above.

Further, the drone 10 may include audio and visual alarms. Again, alarm components are electrically connected to the processor 20 and configured to emit audio or visual alarms when energized by the processor 20, such as when a failure event or crash is imminent as described above. More particularly, the audio alarm may be a loud siren similar to an air raid bombing alert intended to warn civilians of the falling drone. Similarly, a visual alarm may be in the form of a police car or ambulance flashing lights intended to grab the attention of persons on the ground.

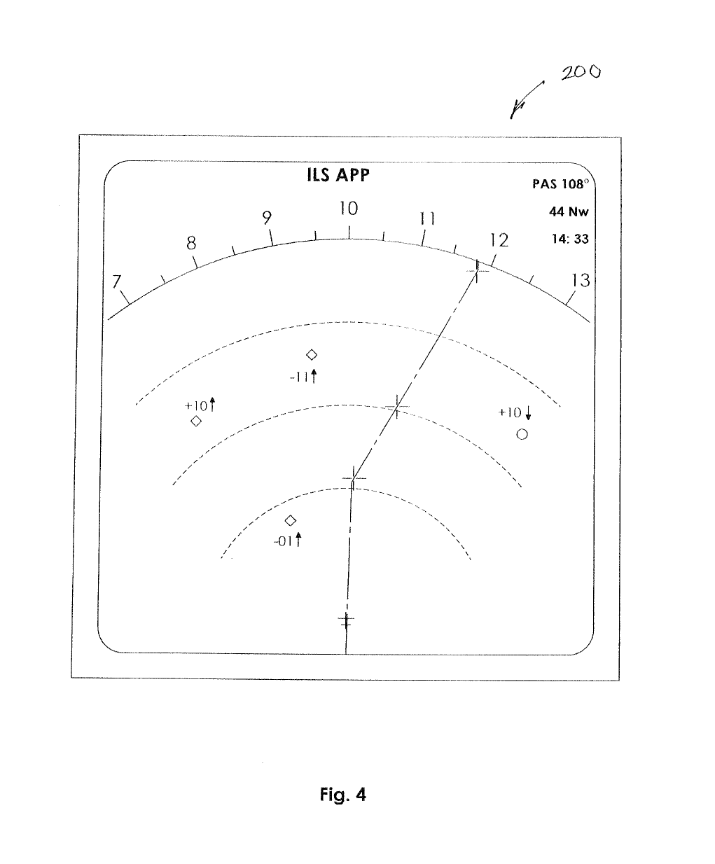

In addition, a global positioning satellite (GPS) module may also be situated in the interior area of the drone housing 12 and in data communication with the processor 20. The GPS module 32 may be configured to continuously or periodically transmit signals to and from the GPS network to determine and record its location in space or configured to begin logging its location when energized to do so by the processor 20. In an embodiment, the processor 20 may be directed by respective programming instructions to energize the GPS module 32 to determine and record GPS position data when a failure event or imminent crash is determined as described above. The GPS data may be transmitted to the central location or predetermined contacts so as to aid location of the drone 10 following an unplanned landing or crash. One of the predetermined contacts may be to a collision avoidance system 200 in airplanes within a predetermined range of the drone housing 12 where the drone's location may be displayed graphically on a display screen along with the locations of all other drones or airplanes also in the predetermined area (FIG. 4). The collision avoidance system 200 may be incorporated into airplanes, all drones within a network, via a mobile application, or other remote locations.

Similarly, a transponder 38 may also be situated in the interior area of the drone housing 12 and, in an embodiment, be in data communication with the processor 20. As described above, the transponder 38 may be configured to begin emitting a digital signal when the processor 20 or circuitry determines a failure event has occurred or a crash is imminent. Alternatively, the transponder 38 may begin functioning when a crash is detected. Further still, the transponder 38 may be configured to only emit a “squawk” signal when prompted (also referred to as “interrogated”) by an emergency search signal. It is understood that the transponder 38 functions substantially the same as transponders in airplanes and the like. The transponder 38 provides yet another way to locate a drone that has crashed or stopped functioning normally.

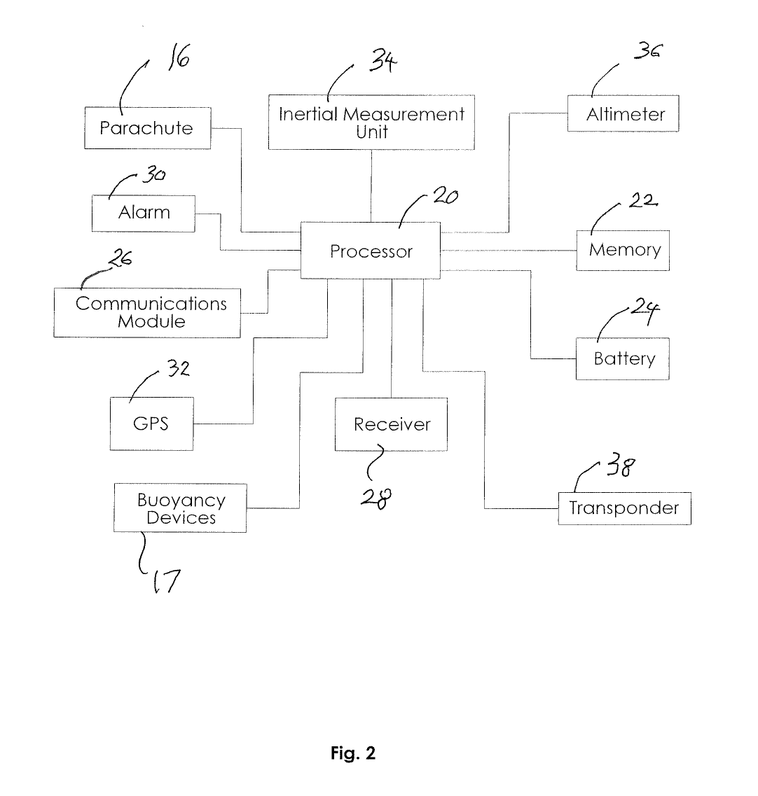

The transponder 38 and other electronics within the drone 10 may be actuated or controlled by a mobile application running on a remote mobile electronic device 18 such as a smart phone. As illustrated in FIG. 2, software in the form of a mobile application running on a mobile electronic device 18 may cause the mobile electronic device 18 to send a cellular signal that may be received by a receiver 28 situated in the drone housing 12 and in data communication with the processor 20. The received signal may be appropriately configured to remotely control the lift system, deploy the parachute, initiate communications or the like.

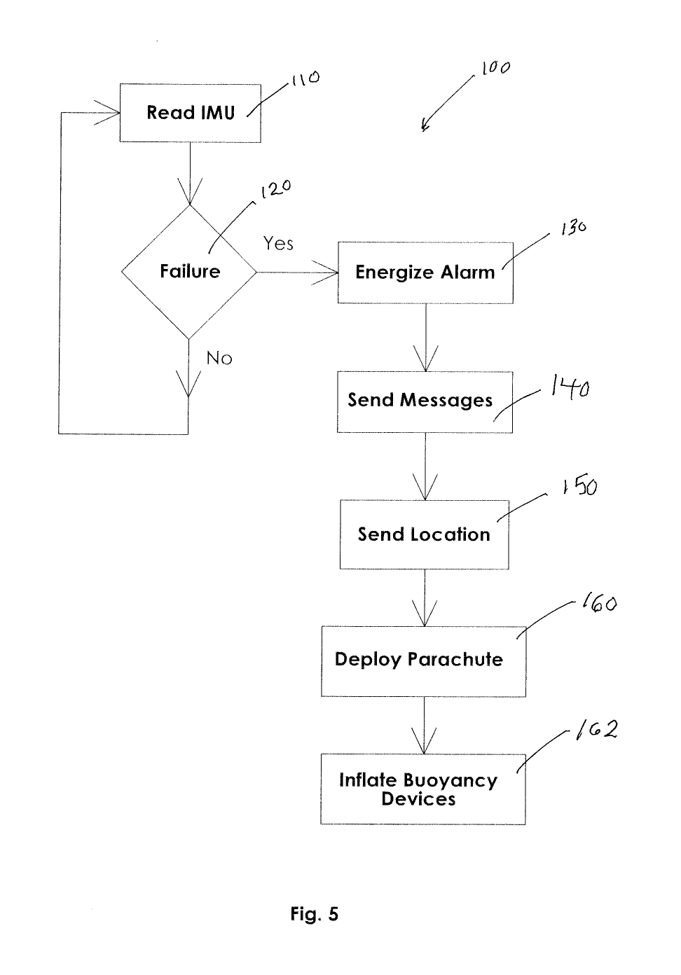

An exemplary method 100 of operation of the present invention is illustrated in FIG. 5. At step 110, an IMU of a UAV is polled (i.e. is read) by the processor 20 to determine if there any indication of failure of the lift system or as may be indicated by speed, elevation, and rotational data as described above. If not, the method returns to step 110 to continue monitoring. But if a failure is indicated, the method 100 continues to steps 130, 140, 150 and 160 to take respective actions. Specifically, the audible alarm is activated at step 130 to alert persons at ground level to take cover. Predetermined authorities and other persons may be notified by telephone, text, email, or the like at step 140 regarding the impending failure. At step 160, actual GPS location data may be transmitted. And, the parachute 16 may be deployed at step 160 for slowing the descent of the failing drone and preventing its damage and that of persons or property on the ground. Further, the buoyancy device 17 may be energized at step 162 to move rapidly to the inflated configuration (FIG. 6b) through either automatic sensing of environmental conditions (i.e. of a water landing) or manually as described above.

In use, a drone 10 may include a conventional lift system and electronic components such as a camera or even military applications. Beyond a traditional drone construction, the drone 10 according to the present invention includes diagnostic and failure detection electronic components and programming. Then, when a failure of the lift system or motion of the drone housing 12 indicates a crash is inevitable or even imminent, efforts to mitigate the damages of a crash are initiated, including deploying a parachute to slow the descent, audible or visual alarms, initiating communications to law enforcement authorities or predetermined contacts, logging of GPS location coordinates, and operation of a transponder. Accordingly, damages that are possible from a catastrophic failure of the drone may be minimized. In addition, operation of the drone and the electronic safety features discussed above may be operated by remote control using a suitably configured mobile application.

It is understood that while certain forms of this invention have been illustrated and described, it is not limited thereto except insofar as such limitations are included in the following claims and allowable functional equivalents thereof.

1. An unmanned aerial vehicle (“UAV”) damage mitigation system for mitigating damages caused by catastrophic failure of the UAV, comprising:
a drone housing having a lift system for lifting and propelling said drone housing into ambient air;
an inertial measurement unit (“IMU”) associated with said drone housing that is configured to detect and generate rate of acceleration data and angular rotation data regarding motion of said drone housing;
a processor positioned in said drone housing and in data communication with said IMU so as to receive said generated acceleration data and said angular rotation data;
wherein said processor is programmed to use said generated acceleration data and said angular rotation data to detect when said speed and angular data determined by said accelerometer is indicative of an impending crash of said drone housing;
an alarm coupled to the drone housing and in data communication with said processor;
wherein said processor is programmed to energize said alarm when the impending crash is imminent.

2. The UAV damage mitigation system as in claim 1, further comprising:
a global position satellite (GPS) module positioned in said drone housing and in data communication with said processor, said GPS module configured to continuously determine and log global location data associated with said drone housing;
a telecommunications module in data communication with said processor and configured to transmit telephonic, email, or satellite signals when energized;
wherein said processor is programmed to energize said telecommunications module to transmit said location data to a plurality of predetermined contacts when the impending crash is detected.

3. The UAV damage mitigation system as in claim 2, wherein:
said processor is in data communication with said lift system and is programmed to detect a failure event associated with said lift system;
wherein said processor is programmed to energize said alarm when either the failure event associated with the lift system is detected or the impending crash of the drone housing is detected.

4. The UAV damage mitigation system as in claim 1, wherein:
said processor is in data communication with said lift system and is programmed to detect a failure event associated with said lift system;
wherein said processor is programmed to energize said alarm when the failure event associated with the lift system is detected.

5. The UAV damage mitigation system as in claim 3, further comprising:
a parachute coupled to said drone housing for slowing a descent of said drone housing when deployed, said parachute being movable between a stowed configuration inside said drone housing and a deployed configuration extending from said drone housing;
wherein said processor is programmed to energize a deployment of said parachute when said failure event or said impending crash is detected.

6. The UAV damage mitigation system as in claim 1, further comprising:
a parachute coupled to said drone housing for slowing a descent of said drone housing when deployed, said parachute being movable between a stowed configuration inside said drone housing and a deployed configuration extending from said drone housing;
wherein said processor is programmed to energize a deployment of said parachute when said failure event or said impending crash is detected.

7. The UAV damage mitigation system as in claim 1, further comprising a non-volatile memory situated in said drone housing and in data communication with said processor, said memory having data structures and programming executable by said processor.

8. The UAV damage mitigation system as in claim 5, further comprising a transponder positioned in said drone housing and in data communication with said processor, said transponder transmitting a predetermined squawk signal when interrogated by a corresponding interrogator signal.

9. The UAV damage mitigation system as in claim 1, further comprising a transponder positioned in said drone housing and in data communication with said processor, said transponder transmitting a predetermined squawk signal when interrogated by a corresponding interrogator signal.

10. The UAV damage mitigation system as in claim 6, further comprising:
a receiver positioned in said drone housing and in data communication with said processor;
a mobile software application installed and executed on a mobile computing device remote from said drone housing that, when executed by the mobile computing device:
transmits control signals for operating said lift system of said drone housing;
transmits deployment signals that cause said processor to energize a deployment of said parachute;
transmits alarm signals that cause said processor to energize sale alarm.

11. The UAV damage mitigation system as in claim 10, further comprising:
a global position satellite (GPS) module positioned in said drone housing and in data communication with said processor, said GPS module configured to continuously determine and log global location data associated with said drone housing;
a telecommunications module in data communication with said processor and configured to transmit telephonic, email, or satellite signals when energized;
wherein said processor is programmed to energize said telecommunications module to transmit said location data to a remote receiver associated with said mobile software application.

12. The UAV damage mitigation system as in claim 11, wherein said mobile application, when executed by the mobile computing device:
receives said location data transmitted by said telecommunications module;
publishes said location data to a display screen associated with the mobile computing device.

13. An unmanned aerial vehicle (“UAV”) damage mitigation system for mitigating damages caused by catastrophic failure of the UAV, comprising:
a drone housing having a lift system for lifting and propelling said drone housing into ambient air;
an inertial measurement unit (“IMU”) associated with said drone housing that is configured to detect and generate rate of acceleration data and angular rotation data regarding motion of said drone housing;
a processor positioned in said drone housing and in data communication with said IMU so as to receive said generated acceleration data and said angular rotation data;
wherein said processor is programmed to use said generated acceleration data and said angular rotation data to detect when said speed and angular data determined by said accelerometer is indicative of an impending crash of said drone housing;
an alarm coupled to the drone housing and in data communication with said processor;
wherein said processor is programmed to energize said alarm when the impending crash is imminent;
a parachute coupled to said drone housing for slowing a descent of said drone housing when deployed, said parachute being movable between a stowed configuration inside said drone housing and a deployed configuration extending from said drone housing;
wherein said processor is programmed to energize a deployment of said parachute when said failure event or said impending crash is detected;
a global position satellite (GPS) module positioned in said drone housing and in data communication with said processor, said GPS module configured to continuously determine and log global location data associated with said drone housing; and
a telecommunications module in data communication with said processor and configured to transmit telephonic, email, or satellite signals when energized;
wherein said processor is programmed to energize said telecommunications module to transmit said location data to a remote receiver associated with said mobile software application.

14. The UAV damage mitigation system as in claim 13, further comprising:
a receiver positioned in said drone housing and in data communication with said processor;
a mobile software application installed and executed on a mobile computing device remote from said drone housing that, when executed by the mobile computing device:
transmits control signals for operating said lift system of said drone housing;
transmits deployment signals that cause said processor to energize a deployment of said parachute;
transmits alarm signals that cause said processor to energize sale alarm.

15. The UAV damage mitigation system as in claim 14, wherein said mobile application, when executed by the mobile computing device:
receives said location data transmitted by said telecommunications module;
publishes said location data to a display screen associated with the mobile computing device.

16. The UAV damage mitigation system as in claim 15, wherein:
said processor is in data communication with said lift system and is programmed to detect a failure event associated with said lift system;
wherein said processor is programmed to energize said alarm when either the failure event associated with the lift system is detected or the impending crash of the drone housing is detected.

17. The UAV damage mitigation system as in claim 16, further comprising a non-volatile memory situated in said drone housing and in data communication with said processor, said memory having data structures and programming executable by said processor.

18. The UAV damage mitigation system as in claim 13, further comprising a transponder positioned in said drone housing and in data communication with said processor, said transponder transmitting a predetermined squawk signal when interrogated by a corresponding interrogator signal.

19. The UAV damage mitigation system as in claim 15, further comprising a buoyancy device coupled to said drone housing for causing said drone housing to float in water when inflated.

20. The UAV damage mitigation system as in claim 15, wherein said computing device is an airplane radar system.
